(19) United States
(12) Patent Application Publication
(10) Pub. No.: US 2010/0250921 A1
(43) Pub. Date: Sep. 30, 2010

(54) Authorizing a Login Request of a Remote Device

(76) Inventors: Gil Spencer, Los Altos, CA (US); David Jevans, Menlo Park, CA (US); Shannon Holland, Los Altos, CA (US); Manish Pandev, San Jose, CA (US); Dan Simon, Santa Clara, CA (US)

Correspondence Address: CARR & FERRELL LLP, 2200 GENG ROAD, PALO ALTO, CA, 94303, US

(21) Appl. No.: 12/412,801

(22) Filed: Mar. 27, 2009

(51) Int. Cl. H04L 9/32; H04L 9/00; G06F 15/16

(52) U.S. Cl. 713/155; 726/7

(57) ABSTRACT

Exemplary systems and methods for managed authorization of a login request of a remote device are provided. A user of the remote device may be authorized to login by an authentication server before attempting to login. Upon receipt of a login request from the remote device, an authorization process is performed. Subsequently, a concatenation of data from the login request and a server response based on the determination of whether the remote device is authorized to login is generated. The server response may comprise instructions to authorize the login request, instructions to deny the login request, or instructions to destroy data stored by the remote device. Furthermore, the authentication server or the remote device may log the server response.

### BACKGROUND OF THE INVENTION

1. Field of the Invention

Embodiments of the present invention relate generally to remote data storage devices, and more particularly to authorization of a login request of remote devices.

2. Description of Related Art

Portable storage devices, such as flash or USB drives, are readily used to transport data. These portable storage devices are typically small in size and lightweight. Due to its portability, the portable storage devices may be easily lost, misplaced, or stolen. Once lost or stolen, data stored on the portable storage devices may be accessed by individuals without authority to view the data. Therefore, it would be advantageous to have a system that will determine a status of a storage device prior to allowing login to the storage device.

### SUMMARY OF THE INVENTION

Embodiments of the present invention provide systems and methods for managed authorization of a login request of a remote device. A user of the remote device may be authorized to login by an authentication server prior to attempting a login process.

Upon receipt of a login request from the remote device, an authorization process is performed according to exemplary embodiments. The authorization process may comprise an exchange of encrypted challenges and responses between the remote device and the authentication server. In exemplary embodiments, a device identifier associated with the remote device may be determined. Using the device identifier, a lookup may be performed to determine a status of the remote device.

Based in part of the status of the remote device, a concatenation of data from the login request and a server response is generated. The server response may comprise instructions to authorize the login request, instructions to deny the login request, or instructions to destroy data stored by the remote device. The concatenation is then returned to the remote device such that the remote device may perform the instructions.

### BRIEF DESCRIPTION OF PROPOSED FIGURES

FIG. 1 is a diagram of an exemplary environment in which embodiments of the present invention may be practiced.

FIG. 2 is a block diagram of an exemplary authentication server.

FIG. 3 is a block diagram of an authorization engine of the authentication server.

FIG. 4 is a flowchart of an exemplary method for authorizing a login request of a remote device.

FIG. 5 is a flow sequence diagram of an exemplary authorization process.

FIG. 6 is a block diagram of a digital device.

### DETAILED DESCRIPTION OF EXEMPLARY EMBODIMENTS

Embodiments of the present invention provide an exemplary system and method for authorizing a login request from a remote device. When a user attempts to login to access data on the remote device, a process is performed to determine if the user is authorized to login prior to performing the login process. Based on the results of the authorization process, a user of the remote device may be allowed to login, the user may not be allowed to login, or data stored on the remote device may be destroyed. Policies which define actions to be taken when the remote device is lost or stolen, or when an employee leaves and does not return the remote device may be established by an administrator.

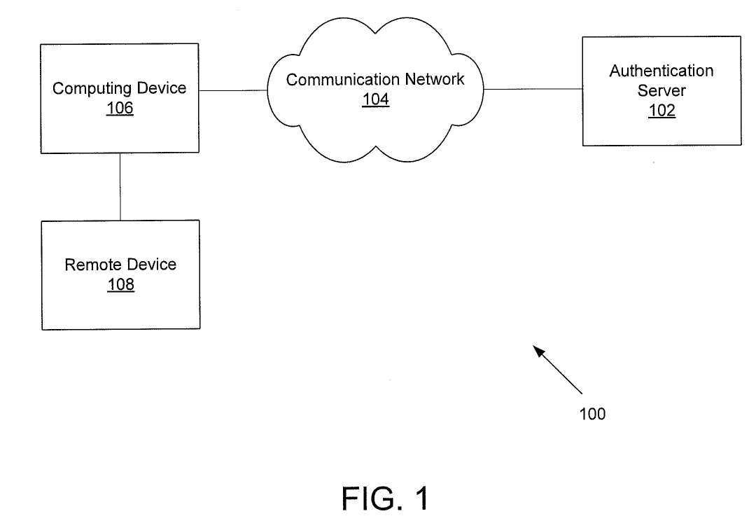

Referring to FIG. 1, a block diagram of an environment 100 in which embodiments of the present invention may operate is shown. In exemplary embodiments, an authentication server 102 is coupled via a communication network 104 to a computing device 106. The communication network 104 may comprise one or more local or wide area networks such as, for example, the Internet.

Prior to accessing data stored on a remote device 108, an authorization process for the remote device 108 is performed by the authentication server 102. Authorization insures that the remote device 108 is registered with the authentication server 102 and that the remote device 108 is not reported lost or stolen or that a former employee has not returned the remote device 108, for example. When the remote device 108 is reported lost or not returned, an individual (e.g., administrator) may flag the remote device 108. The flag may be stored such that upon a next login attempt, the remote device 108 may be denied login or data on the remote device 108 may be destroyed. If authorized to login, however, a login process may then be activated to allow the user of the remote device 108 to login and access the data stored on the remote device 108.

Policies which define actions to be taken when the remote device 108 is lost or stolen, or when an employee leaves and does not return the remote device 108 may be established by an administrator. For example, the administrator may deny access to the remote device 108 until status of the remote device 108 is verified. Furthermore, the remote device 108 may be disabled such that the next time the remote device 108 couples to the communication network 104, the authentication server 102 locks out the user completely. As such, embodiments of the present invention allow enterprise security professionals (e.g., administrators) to remotely manage countless number of remote devices 108 over the communication network 104.

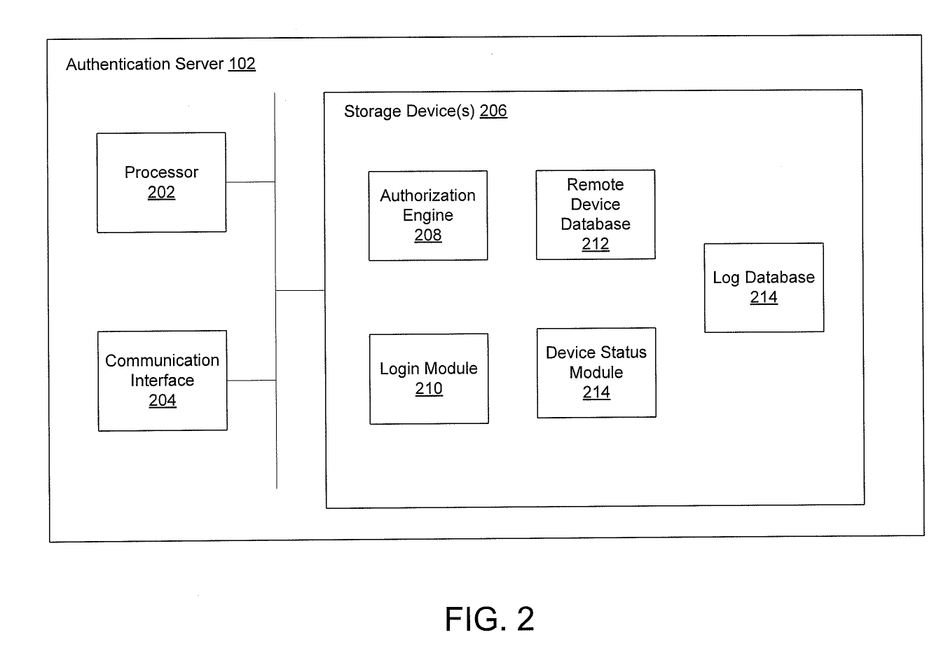

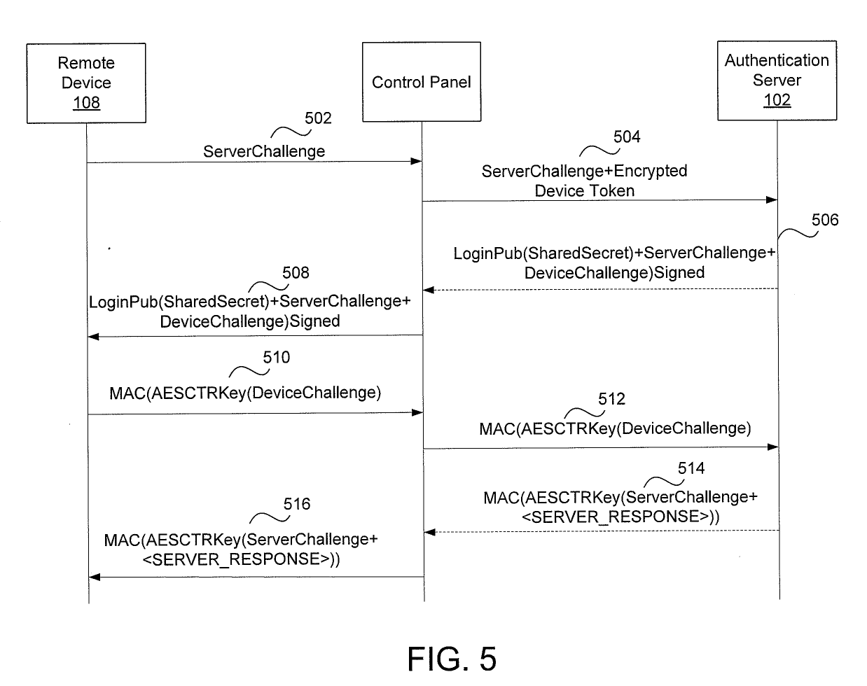

Along with allowing/denying access and destroying the remote device 108, exemplary embodiments also allow remote tracking of the remote devices 108 and reporting capabilities for auditing and compliance purposes. The authentication server 102 will be discussed in more detail in connection with FIG. 2 below. Additionally, the authorization process will be discussed in more detail in connection with FIG. 5.

The remote device 108 may be coupled to the computing device 106 for access to data stored on the remote device 108. In exemplary embodiments, the remote device 108 may comprise a computer readable storage medium such as, for example, a USB flash drive or other small disk drives. The remote device 108 stores information and/or instructions which may be accessed via the computing device 106 when coupled to the computing device 106 (e.g., via a USB port).

Prior to accessing data on the remote device 108, an authorization process is performed by the authentication server 102. If authorized, a login process may then be activated to allow the user of the remote device 108 to access data on the remote device 108. If not authorized, the login process is denied. Alternatively, instructions may be generated to destroy data stored by the remote device 108. Instructions to destroy the data may initiate a self-destruct sequence, which destroys internal circuitry resulting in permanent destruction of the remote device 108 in accordance with some embodiments.

The computing device 106 may comprise any device which can communicate with the authentication server 102 and can access data stored on the remote device 108. The computing device 106 may provide the conduit for authorizing the user of the remote device 108 and for logging in the user to access the data stored on the remote device 108. In exemplary embodiments, the computing device 106 may access and operate a control panel module from the remote device 108 upon the remote device 108 being coupled to the computing device 106. The control panel module may be launched from a virtual CD-ROM on the remote device 108. In various embodiments, the computing device 106 may be a desktop computer or laptop computer.

Once launched, the control panel running on the computing device 106 acts as the conduit for passing of data between the remote device 108 and the authentication server 102. The computing device 106 does not decrypt any of the data that is passed back and forth, nor does the computing device 106 have any visibility as to the data. Advantageously, this prevents a hacker from modifying the control panel to affect the behavior of the remote device 108.

The environment 100 of FIG. is exemplary. Alternative embodiments may comprise a plurality of computing devices 106 in communication with one or more authentication servers 102 to authorize login request of any number of remote devices 108 and still be within the scope of exemplary embodiments.

Referring now to FIG. 2, a block diagram of the exemplary authentication server 102 is shown. In exemplary embodiments, the authentication server 102 comprises a processor 202, one or more communication interfaces 204, and at least one storage device 206. The communication interfaces 204 are configured to enable the authentication server 102 to communicate via the communication network 104. In various embodiments, the communication interfaces 204 may comprise ports, other hardware, firmware, and/or software that allow for communications to and from the authentication server 102.

The storage device(s) 206 may comprise storage mediums for a plurality of applications, components, databases, and modules. In the present embodiment, the storage device(s) 206 comprises an authorization engine 208, a login module 210, a remote device database 212, a device status module 214, and a log database 216. In various embodiments, the storage device(s) 206 may comprise memory devices, tape, disks, or integrated circuits. It should be noted that while various modules are illustrated as being embodied on the storage device 206, alternative embodiments may provide the modules as hardware.

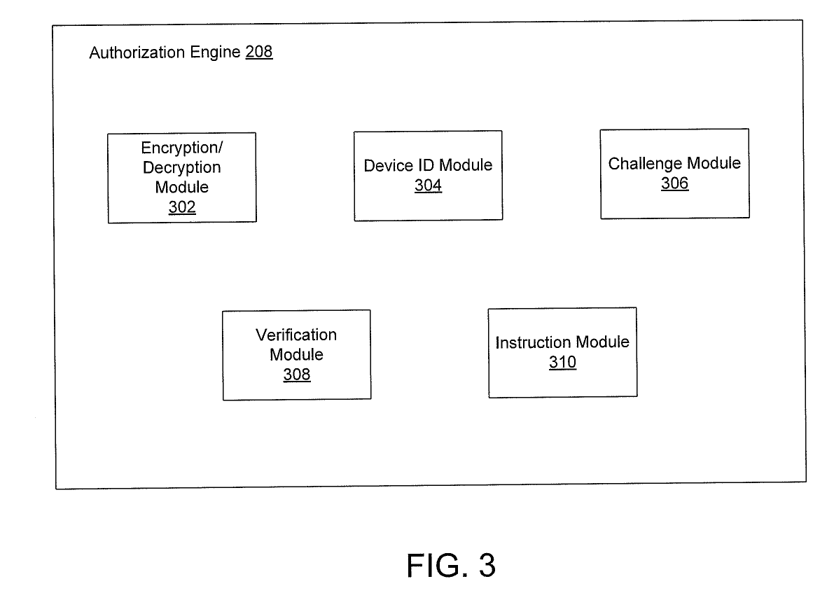

The exemplary authorization engine 208 is configured to perform the authorization process. Authorization processing is performed prior to allowing a user associated with the remote device 108 to login and access data on the remote device 108. In essence, the authorization engine 208 is a first stage or a two-stage data access process whereby the authorization engine 208 provides permission for a second stage (i.e., the login process) of the two-stage data access process. The authorization engine 208 will be discussed in more detail in connection with FIG. 3.

In exemplary embodiments, the login module 210 performs the login processing of the user of the remote device 108 (i.e., the second stage of the two-stage data access process). The exemplary login module 210 may receive a password from the user of the remote device 108. The login module 210 may then access the remote device database 212 to verify the password against stored passwords for a plurality of remote devices 108. If the password is verified, then the user is allowed access to the data stored on the remote device 108.

The remote device database 212 is configured to store information regarding each remote device 108 managed by the authentication server 102. In various embodiments, the remote device database 212 may include, for example, device identifiers, user name and password combinations, status for each remote device 108, flags, and policies to apply to remote devices 108. The status may indicate if the remote device 108 is lost or stolen, for example, while the policies indicate actions with respect to the login request (e.g., whether to not allow login or destroy).

The exemplary device status module 214 is configured to maintain the status and authorization attempts of the remote device 108. In some embodiments, the device status module 214 may log every authorization/login attempt. These logs may include time, date, and location of each attempt. The device status module 214 may also detect abnormities in attempts. For example, if a last access attempt is from one location (e.g., U.S. on April 10^{th}) and a current access attempt is from a different geographical location (e.g., China on April 11^{th}), then the current access attempt may be flagged as suspicious. In some embodiments, the device status module 214 may also perform auditing and reporting functions.

The log database 216 is configured to store all attempts for access to data stored on remote devices 108 managed by the authentication server 102. The log database 216 may include IP addresses from which access attempts have been initiated. In some embodiments, a list of safe IP addresses may be stored at the authentication server 102. It should be noted that the log database 216 may be embodied within the remote device database 212 in accordance with some embodiments.

The embodiment of FIG. 2 is exemplary. Alternative embodiments may comprise more, less, or combine components and still be within the scope of exemplary embodiments. For example, the device status module 214 may be embodied within the authorization engine 208.

Referring now to FIG. 3, the authorization engine 208 is shown in more detail. In exemplary embodiments, the authorization engine 208 is configured to perform server-encrypted exchanges with the remote device 108 to determine if a user of the remote device 108 is authorized to access the remote device 108. The authorization engine 208 may comprise an encryption/decryption module 302, a device identifier module 304, a challenge module 306, a verification module 308, and an instruction module 310. Alternative embodiments may comprise more, less, or similar components or combine the functionalities of some of the components of the authorization engine 208.

The encryption/decryption module 302 is configured to encrypt and decrypt data exchanged with the remote device 108. Specifically, the encryption/decryption module 302 decrypts challenges and responses received from the remote device 108 and encrypts any challenges and responses to the remote device 108.

The exemplary device identifier module 304 determines the device identifier of the remote device 108 from which a current login request is received. In exemplary embodiments, the device identifier is a series of bytes that identifies the remote device 108. The series of bytes may be comprised within a device token. The device token is a private key encrypted block that contains information about the remote device 108. The device token may be generated and embedded into the remote device 108 at the time of creation and provisioning of the remote device 108. In exemplary embodiments, the device identifier module 304 may determine the unique device identifier from the device token. The device identifier module 304 may also use the device identifier and perform a lookup in the remote device database 212 to verify that the remote device 108 and any corresponding records exist.

The challenge module 306 generates challenges to be sent to the remote device 108. In one embodiment, the challenge module 306 generates a “shared secret” in conjunction with a device challenge. The shared secret, according to one embodiment, is a symmetric encryption key (e.g., 128 bit number) concatenated with a message authentication code (MAC) key. The MAC key may comprise a hashing mechanism used to identify a piece of data. Thus, by applying the MAC key to the symmetric encryption key, a uniquely identified piece of data may be generated.

The exemplary verification module 308 is configured to verify the remote device 108. In exemplary embodiments, the verification module 308 will receive a response from the remote device which includes the device challenge as well as the encrypted MAC of the data. If the response matches the device challenge that was sent, then the verification module 308 verifies the remote device 108 on the authentication server 102. Once verified, a response to the login request may be generated and provided to the remote device 108. In some embodiments, the verification module 308 may access the remote device database 212 and determine the login access status associated with the remote device 108.

The instruction module 310 is configured to provide instructions for login access based in part on the results from the verification module 308. In exemplary embodiments, the instruction module 310 may take the server challenge that was originally received from the remote device 108 and concatenate the server challenge with a server response. The server response may comprise instructions to authorize a login request, instructions to deny the login request, or instructions to destroy data stored on the remote device 108. The combination of the server challenge and server response is then sent back to the remote device 108.

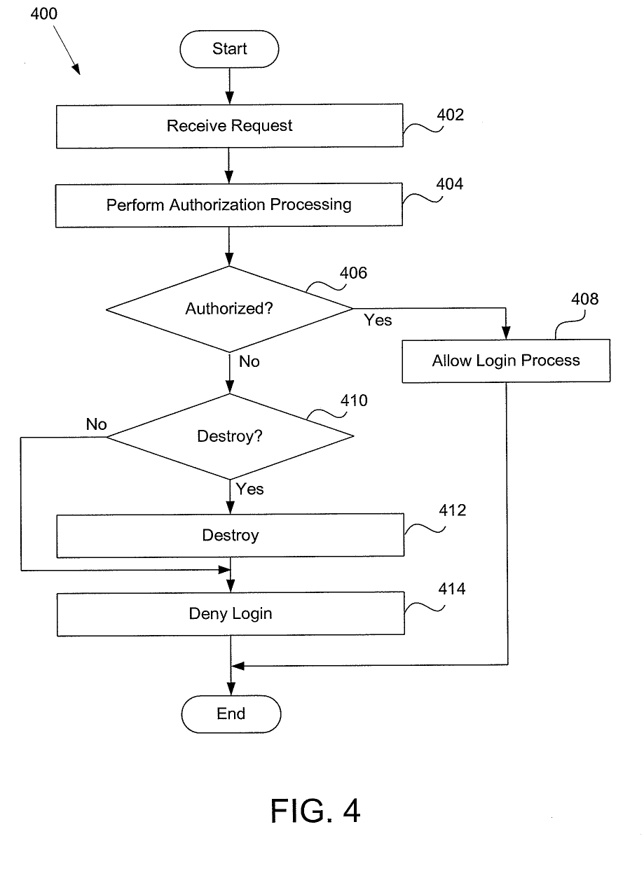

Referring now to FIG. 4, a flowchart 400 of a method for authorization or a login request from a remote device 108 is shown. In step 402, a login request is received from the remote device 108. In exemplary embodiments, the login request may be automatically initiated when the remote device 108 is coupled to a computing device 106 used as a conduit for communication.

Once received, the authorization process is performed in step 404. The authorization process will determine a status associated with the remote device 108, verify the remote device 108, and send instructions regarding whether the remote device 108 is allowed to login. In exemplary embodiments, the authorization process is performed as illustrated in connection with FIG. 5 below.

Based on the results of the authorization processing, if the remote device 108 is authorized in step 406, then the login process is initiated in step 408. The login process may comprise receipt of a login password. In exemplary embodiments, the user may be allowed a particular number of tries to enter the login password. In some embodiments, if the login password is not provided in the particular number of tries, then a self-destruct mechanism may be initiated whereby the data on the remote device 108 may be destroyed.

If the remote device 108 is not authorized in step 406, then if the status requires the data in the remote device 108 be destroyed in step 410, then data on the remote device 108 is destroyed in step 412. In one embodiment, internal circuitry of the remote device 108 may be permanently destroyed in step 412. However, if the status does not require destroying the data on the remote device 108, then the login process is denied in step 414. Denial of the login process may trigger display of a message on the coupled computing device 106. In these embodiments, the remote device 108 may need to be verified in some way with the authentication server 102 prior to reactivation of the remote device 108 and allowance of subsequent login requests (e.g., the remote device may need to be provided to an administrator).

Referring now to FIG. 5, a challenge and response flow sequence of an exemplary authentication process (step 404) is shown. As illustrated, various challenges and responses are exchanged between the remote device 108 and the authentication server 102 via the computing device 106. In one embodiment, one or more challenges and responses are encrypted. When the remote device 108 is initially coupled to the computing device 106, a control panel module stored on the remote device 108 is activated via the computing device 106. The resulting control panel acts as the conduit for communication exchanges.

A server challenge is first requested by the control panel from the remote device 108. In response, the remote device 108 generates and provides the server challenge in sequence 502. In exemplary embodiments, the server challenge comprises a random number that is generated by firmware on the remote device 108. The server challenge may be generated each time the authorization process is performed.

Using the server challenge, the control panel will initiate a login request to the authentication server 102 in sequence 504. The login request may comprise the server challenge and an encrypted device token. The device token may comprise a device identifier which is a series of bytes that identifies the remote device 108. This first call to the authentication server 102 may be initiated by the remote device 108 over an HTTPS connection in accordance with some embodiments. Subsequent communications mat be via a secure channel using AES-CTR mode as an encryption mechanism to secure communications between the authentication server 102 and firmware of the remote device 108. As a result, the control panel may act as a conduit for passing encrypted packets of information between the firmware and the authentication server 102.

The device token is a private key encrypted block that contains information about the remote device 108. In one embodiment, the device token is encrypted with a 4096 bit private key. The device token is a unique device identifier (e.g., a series of bytes) that may be generated and assigned to the remote device 108 upon creation. In one embodiment, the device token may be embedded on a security chip (e.g., in a public box) of the remote device 108.

The authentication server 102 receives and processes the login request. If the login request is encrypted, the authentication server 102 will first decrypt the login request using the encryption/decryption module 302. Once decrypted, the device identifier (e.g., the device token) may be extracted by the device identifier module 304. The device identifier is then used to perform a lookup in the remote device database 212. If the remote device 108 exists in the remote device database 212, a status of the remote device 108 may be returned.

The authentication server 102 then generates a second challenge using the challenge module 306. The second challenge may comprise a “shared secret” combined with the original server challenge and a generated device challenge. In exemplary embodiments, the shared secret may be a symmetric encryption key comprising a 128-bit number (e.g., an AS key) concatenated with a message authentication code (MAC) key. The MAC may be a hashing mechanism used to identify a piece of data. As such, the symmetric encryption key may be processed with a MAC algorithm to generate a uniquely identified piece of data. The second challenge may be signed (with a signature) and the second challenge, or parts of the second challenge, may be encrypted by the encryption/decryption module 302. The signature may comprise a private key of the authentication server 102. The second challenge is then sent back to the control panel in sequence 506. In some embodiments, the authentication server 102 may also return a session cookie with the second challenge. The session cookie is a HTTP cookie used for tracking a session between the control panel and the authentication server 102.

The control panel may then establish a secure channel with the firmware of the remote device 108. Once established, the second challenge may be passes to the remote device 108 in sequence 508.

The remote device 108 receives and processes the second challenge. Firmware of the remote device 108 may decrypt the second challenge and may verify the signature using a copy of the authentication server's public key which may be stored on the remote device 108. In exemplary embodiments, the remote device 108 also derives a symmetric encryption key and a MAC key. The result should be the same MAC key, which will verify the integrity and origin of the data. The remote device 108 may also verify that the server challenge received in the second challenge is the same server challenge originally sent. Because each remote device 108 comprises a login private key specific to each remote device 108, the remote device 108 will be able to perform a private key decryption and login to get the shared secret and verify the server challenge.

The firmware of the remote device 108 then takes the shared secret and separates it into its two components—the symmetric encryption key and the MAC key. Subsequently, the remote device 108 takes the MAC of the symmetrically encrypted device challenge and sends it to the control panel in sequence 510. The control panel then passes the MAC of the symmetrically encrypted device challenge along with the session cookie through to the authentication server 102 in sequence 512.

The authentication server 102 will now verify the remote device 108. In exemplary embodiments, the verification module 308 will verify the MAC key, decrypt the symmetrically encrypted device challenge, and verify the device challenge.

At this point, the authentication server 102 and the remote device 108 are established with each other, and the authentication server 202 may determine the status of the remote device 108. Based, in part, on the lookup of the remote device database 212, the remote device 108 may be allowed to login, may not be allowed to login, or data on the remote device 108 may be destroyed. As such, a server response may comprise instructions that authorizes login, does not authorize login, or destroys data. In exemplary embodiments, the instruction module 310 concatenates this server response with the server challenge that was originally received from the remote device 108 to generate a concatenation that will be returned to control panel in sequence 514 along with the session cookie. The concatenation may be encrypted and a MAC applied to the concatenation. In some embodiments, a tag may be generated comprising the concatenation and the MAC. The concatenation and MAC are then sent to the remote device 108 for verification in sequence 516.

The remote device 108 receives the concatenation and verifies the MAC. The concatenation may be decrypted to access the server response and the server challenge. The server challenge may then be verified, and the server response may be initiated. If the server response is authorization of login, then the login data will be submitted. If the server response is non-authorization of login, then a message may be provided (e.g., a pop up window on the computing device 106) that indicates non-authorization. If the server response is destroyed, then a self-destruct may be initiated.

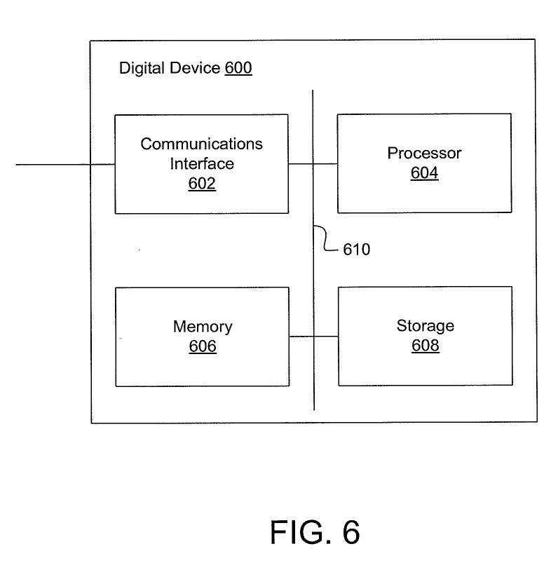

FIG. 6 is a block diagram of an exemplary digital device 600 that may be used. The digital device 600 may comprise devices associated with the authentication server 102 and the computing device 106 according to exemplary embodiments. The computing device 600 comprises a communications interface 602, a processor 604, a memory 606, and storage 608, which are all coupled to a bus 610. The bus 610 provides communications between the communications interface 602, processor 604, memory 606, and storage 608. The processor 604 executes instructions, while the memory 606 permanently or temporarily stores data. Some examples of the memory 606 are RAM and ROM. The storage 608 may also permanently or temporarily stores data. Some examples of the storage 608 are hard disks and disk drives.

The embodiments of computing device 600 discussed herein are illustrative. As these embodiments are described with reference to illustrations, various modifications or adaptations of the methods and/or specific structures described may become apparent to those skilled in the art.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

1. A computer-implemented method for authorizing a login request of a remote device, comprising:
receiving the login request from the remote device at an authentication server;
determining if the remote device is authorized to login by the authentication server;
concatenating data from the login request and a server response based on the determination of whether the remote device is authorized to login; and
sending the concatenation to the remote device.

2. The method of claim 1 wherein the data from the login request comprises a server challenge generated by the remote device.

3. The method of claim 1 further comprising encrypting the concatenation.

4. The method of claim 3 further comprising generating a tag comprising the encrypted concatenation.

5. The method of claim 4, wherein the tag comprises a message authentication code.

6. The method of claim 3, wherein the encrypting is symmetric.

7. The method of claim 3, wherein the encrypting is asymmetric.

8. The method of claim 1, further comprising logging the server request.

9. The method of claim 1, wherein the server response comprises instructions to authorize the login request.

10. The method of claim 9 further comprising receiving a login password and using the login password in a login process.

11. The method of claim 1, wherein the server response comprises instructions to deny the login request.

12. The method of claim 1, wherein the server response comprises instructions to destroy data stored by the remote device.

13. The method of claim 1, wherein determining if the remote device is authorized to login comprises determining a device identifier of the remote device and reviewing a status associated with the device identifier.

14. A system for authorizing a login request of a remote device, comprising:
a verification module configured to determine, in part, if the remote device is authorized to login;
an instruction module configured to concatenate data from the login request and a server response based on the determination from the verification module; and
a communication interface configured to receive the login request from the remote device and configured to send the concatenation to the remote device.

15. The system of claim 14 further comprising a device identifier module configured to determine a device identifier associated with the remote device.

16. The system of claim 15 further comprising at least one database storing remote device information, the device identifier being used to look up status of the remote device in the at least one database.

17. The system of claim 14 further comprising a challenge module configured to generate a device challenge to the remote device.

18. The system of claim 14 further comprising a device status module configured to maintain and access remote device status information stored in one or more databases.

19. The system of claim 14 wherein the server response comprises instructions to allow login of the remote device.

20. The system of claim 14 wherein the server response comprises instruction to not allow login of the remote device.

21. The system of claim 14 wherein the server response comprises instructions to destroy data on the remote device.

22. A machine-readable medium having embodied thereon a program, the program comprising instructions operable by a processor for providing a method for authorizing a login request of a remote device, comprising:
receiving the login request from the remote device at an authentication server;
determining if the remote device is authorized to login by the authentication server;
concatenating data from the login request and a server response based on the determination of whether the remote device is authorized to login; and
sending the concatenation to the remote device.
